(19) United States
(12) Patent Application Publication
(10) Pub. No.: US 2005/0251519 A1
(43) Pub. Date: Nov. 10, 2005

(54) Efficient language-dependent sorting of embedded numerics

(75) Inventor: Mark Edward Davis, Menlo Park, CA (US)

Correspondence Address: MIN, HSIEH & HACK LLP, 8270 GREENSBORO DRIVE, SUITE 630, MCLEAN, VA, 22102, US

(73) Assignee: INTERNATIONAL BUSINESS MACHINES CORPORATION

(21) Appl. No.: 10/840,273

(22) Filed: May 7, 2004

(51) Int. Cl. G06F 7/00

(52) U.S. Cl. 707/100

(57) ABSTRACT

The present invention relates generally to the processing and collation of character strings. One or more attributes associated with the character strings indicate whether numeric sorting is requested. Non-numeric characters or characters other than numbers, such as letters, may be encoded based on a predetermined set of collation elements. Numbers embedded in the character string are encoded based on an additional set of collation elements. The additional set of collation elements is interleaved or inserted into an open range in the predetermined set of collation elements. The character strings may then be converted based on the predetermined set of collation elements and the additional set of collation elements. The character strings may be numerically sorted based either on a direct comparison with each other or based on a sort key that is derived from the collation elements.

### FIELD

The present invention relates to sorting character strings, and more particularly, it relates to language-dependent sorting of character strings having embedded numeric characters.

### BACKGROUND

Computer systems and processors handle character strings, such as letters, numbers, symbols, and the like, based on sets of standardized character codes. A prevalent function of handling character strings is sorting. Collation is the general term for the process of determining the sorting order of strings of characters. Collation is a key function in computer systems, for example, whenever a list of strings is presented to users in a sorted order so that they can easily and reliably find individual strings. Collation is also crucial for the operation of databases, not only in sorting records but also in selecting sets of records with fields within given bounds.

However, collation can vary dramatically depending on language, culture, and application. This is because character strings may include characters with attributes that vary across languages and culture. These attributes may include attributes for numeric characters, alphabetic characters, “Kana” or “Kanji” characters, accents, etc. As a result, English, Japanese, Germans, French and Swedes, for example, may each sort characters differently. Collation may also vary by specific application, even within the same language. Dictionaries may sort differently than phonebooks or book indices. For non-alphabetic scripts such as East Asian ideographs, collation can be either phonetic or based on the appearance of the character.

Collation can also be commonly customized or configured according to user preference, such as ignoring punctuation or not, putting uppercase before lowercase (or vice versa), etc. Thus collation implementations must often deal with complex linguistic conventions and provide for common customizations based on user preferences.

Conventionally, when sorting character strings, the character codes of the characters at the beginning of the individual character strings are compared with one another. In the case of a sort in ascending order, the character strings are rearranged such that a character string of which the head character has a smaller character code value comes first. In the case of sort in descending order, character strings are rearranged such that a character string of which the head character has a greater character code value appears first. During a sort, if the characters codes compared have the same value, the code values of subsequent characters are compared with each other. A number of complications may also be introduced as part of a sort when handling characters of different languages. In this manner, all character strings can be sorted.

Unfortunately, conventional collation often fails to sort character strings appropriately. For example, the numeric character “2” has a greater character code value than “1.” Therefore, as noted above, when the character strings “10” and “2” are compared with each other, the character code of “1” (i.e., the head character of “10”) is compared with that of “2.” Consequently, conventional collation will judge that “2” has a greater value and thus is greater than “10.” When the character strings are to be treated as numerical values for arithmetic purposes, however, the judgment that “2” is greater than “10” is clearly improper.

An even more difficult problem is the sorting of character strings having embedded numeric characters. Conventional collation cannot be applied in such cases because, for example, the character codes of text characters have very different attributes from numeric characters. For example, for an ascending sort, “A-10” is often sorted ahead of “A-2”, or “Copy 3” before “Copy 295.” In general, a typical user would expect these strings to be sorted in the order of “A-2” and then “A-10”, or “Copy 3” ahead of “Copy 295.” Known systems, such as the Macintosh operating system and the Windows operating system, may supply options to force a numeric sort, whereby embedded numbers will sort in numeric order, not alphabetical order.

Unfortunately, in order to provide this feature and others, the known systems often suffer from slow performance. In addition, in these known systems, the performance the sorting of character strings suffer even if strings do not contain numeric characters.

### SUMMARY

In accordance with the principles of the present invention, characters may be processed based on at least one attribute and encoded based on one or more sets of predetermined collation elements. A string that includes a sequence of characters is received. At least one attribute for the string may indicate numeric ordering. An open range of values is located within the sets of predetermined collation elements. A first set collation elements is identified for characters other than numbers, such as letters or symbols, in the string based on the predetermined collation elements. One or more numbers may also be identified in the string. An additional set of collation elements is determined for the numbers in the string. The additional set of collation elements includes respective sets of weight values based on the location of the open range. A numerically comparable key may then be determined for the string. The key for the string is determined based on the first set of collation elements for the characters other than numbers and the additional set of collation elements for the numbers.

In accordance with the principles of the present invention, strings of characters may be collated based on at least one attribute. Characters other than numbers, such as letters or symbols, are converted into bit sequences based on one or more sets of predetermined collation elements. Numeric characters are converted into bit sequences based on an additional set of collation elements. The additional set of collation elements is interleaved within one or more gaps in the sets of predetermined collation elements. A first and second string of characters may be received. At least one attribute for the first and second strings may be checked to determine whether numeric ordering is indicated. The first and second strings may then be converted into respective bit sequences based on the predetermined collation elements and the additional set of collation elements when the at least one attribute indicates numeric ordering. At least a portion of the bit sequences for the first and second strings are compared. The first and second strings of characters may then be numerically sorted based on the comparison of the bit sequences.

Additional features of the invention will be set forth in part in the description which follows, and in part will be obvious from the description, or may be learned by practice of the invention. The features of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 illustrates a computer system that is consistent with the principles of the present invention;

FIG. 2 illustrates an example of a software architecture for system that is consistent with the principles of the present invention;

FIG. 3a illustrates a typical collation element table that is consistent with the principles of the present invention;

FIG. 3b illustrates a first collation element format that is consistent with the principles of the present invention;

FIG. 3c illustrates a second collation element format that is consistent with the principles of the present invention;

FIG. 4 illustrates a sort key that is consistent with the principles of the present invention;

FIG. 5 illustrates a process flow for processing characters in accordance with the principles of the present invention; and

FIG. 6 further illustrates the process for generating a sort key that is numerically comparable in accordance with the principles of the present invention.

### DESCRIPTION OF THE EMBODIMENTS

In general, processors and computers handle letters, numbers, and other characters by converting them into one or more sequences of numbers or numeric codes. There are several well known encoding systems for handling characters. For example, organizations, such as the American Standard Code for Information Interchange (“ASCII”), the Unicode Consortium and the International Organization for Standardization (“ISO”), publish and maintain standards for encoding characters. These encoding systems often support different languages and locale-dependent variations, such as accents, that affect the characters and their use. For example, the countries of the European Union alone require several different sets of encodings to cover all its languages, such as English, French, German, Spanish, etc. In addition, even a single language like English may use a wide variety of characters for punctuation, and technical symbols.

Collation is a common feature that is based on these encoding systems. Collation relates to the sorting of characters or character strings. Collation is often an important function whenever a list of strings is sorted for presentation to a user. Collation is also a common operation used by databases, for example, when records are being sorted or when sets of records having fields within given bounds are requested.

In order to support collation, encoding systems often specify one or more sets of “collation elements.” In order to support standardized operations across various computer systems, each character is assigned one or more sets of predetermined collation elements. For example, the Unicode consortium supplies a Default Unicode Collation. Element Table (“DUCET”) that sets forth the predetermined collation elements that conform to the Unicode standard. Likewise, ISO also provide their own set of predetermined collation elements that conform to their respective standards.

However, collation may not be uniform in all circumstances. In particular, collation may vary according to language and culture. For example, English, Germans, French and Swedes may sort the same characters differently. Collation may also vary by specific application, even within the same language. Dictionaries may sort differently than phonebooks or book indices. For some languages, such as East Asian ideographs, collation can be either phonetic or based on the appearance of the character. Collation may also be customized or configured according to user preference, such as ignoring punctuation or not, preferring uppercase before lowercase (or vice versa), etc.

Embodiments of the present invention relate to methods and systems for processing characters, including the collation of character strings having embedded numeric characters. In some embodiments, characters may be processed based on an additional set of collation elements as well as the predetermined set of collation elements. The additional set of collation elements may be inserted or interleaved into one or more open ranges in the predetermined set of collation elements.

Characters other than numbers in a string, such as letters or symbols, are encoded based on the predetermined set of collation elements. However, when one or more attributes indicate that the string should be numerically comparable, then numbers in the string are identified and encoded based on the additional set of collation elements. Unlike other techniques that limit collation to a predetermined range of numbers in a string or pad numbers in a string to a predetermined size, the embodiments consistent with the present invention support collation of strings having embedded numbers of any magnitude (or size) or number of digits. In addition, embodiments of the present invention may also support collation of strings having negative as well as fractional numbers. Once the character strings are encoded, they may be collated in various ways.

For example, embodiments of the present invention support collation based on direct comparison of the strings or based on sort keys. Either scheme of collation may be used by embodiments of the present invention because both schemes may be designed to produce the same sorting order of strings. In those embodiments that use direct comparison, both character strings may be processed incrementally. For example, for each character string, successive numeric values may be generated based on their corresponding collation elements. The numeric values for a first and second string may then be compared to each other. In some embodiments, when a primary difference is detected, the comparison may be stopped and the strings may be ordered based on this primary difference. If the end of a string is reached (e.g., indicating that no primary difference was detected), then the strings may be ordered based on lower level differences, such as a secondary or tertiary difference. If no differences are found, then a value may be returned to indicate that the strings order identically.

Alternatively, other embodiments may perform collation based on sort keys. In general, a sort key may be generated for each string and then a binary comparison may be performed of those sort keys. The sort key for each character string may be determined as a function of the collation elements. In addition, the sort key for a particular character string may be formatted such that it relates to the entire string while also rendering the string numerically comparable with other strings. This also may allow a more compact or shorter key to be used for the character strings. The sort keys for the character strings may then be stored and retrieved for sorting their respective character strings.

Reference will now be made in detail to the exemplary embodiments of the invention, examples of which are illustrated in the accompanying drawings. Wherever possible, the same reference numbers will be used throughout the drawings to refer to the same or like parts.

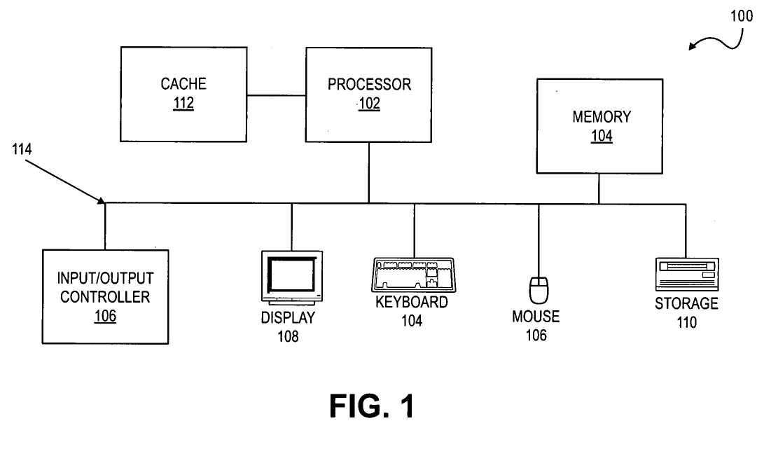

FIG. 1 illustrates a computer system 100 that is consistent with the principles of the present invention. Computer system 100 may be programmed with software to perform collation in accordance with the principles of the present invention. Examples of the components that may be included in computer system 100 will now be described.

As shown, a computer system 100 may include a central processor 102, a main memory 104, an input/output controller 106, a keyboard 104, a pointing device 106 (e.g., mouse, or the like), a display 108, and a storage device 110. Processor 102 may further include a cache memory 112 for storing frequently accessed information. Cache 112 may be an “on-chip” cache or external cache. System 100 may also be provided with additional input/output devices, such as a printer (not shown). The various components of the system 100 communicate through a system bus 114 or similar architecture.

Although FIG. 1 illustrates one example of a computer system, the principles of the present invention are applicable to other types of processors and systems. That is, the present invention may be applied to any type of processor or system that performs collation. Examples of such devices include personal computers, servers, handheld devices, and their known equivalents.

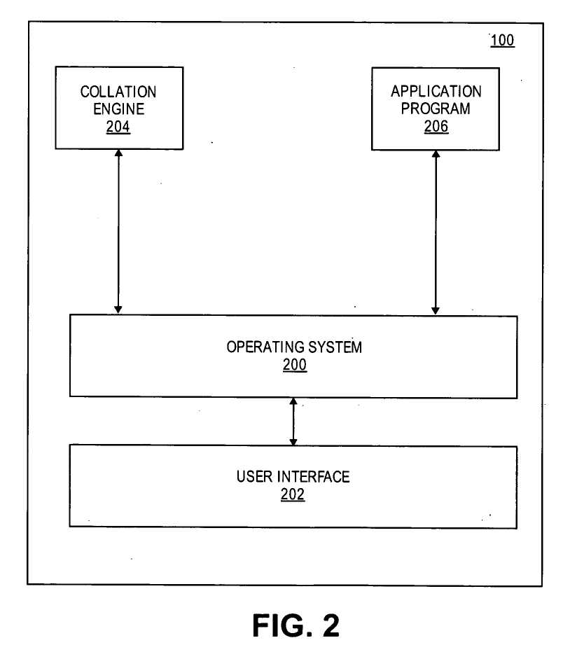

FIG. 2 illustrates an example of a software architecture for system 100 that is consistent with the principles of the present invention. As shown, the software architecture of computer system 100 may include an operating system (“OS”) 200, a user interface 202, a collation engine 204, and one or more application software programs 206. These components may be implemented as software, firmware, or some combination of both, which is stored in system memory 104 of system 100. The software components may be written in a variety of programming languages, such as C, C++, Java, etc.

OS 200 is an integrated collection of routines that service the sequencing and processing of programs and applications by computer system 100. OS 200 may provide many services for computer system 100, such as resource allocation, scheduling, input/output control, and data management. OS 200 may be predominantly software, but may also comprise partial or complete hardware implementations and firmware. Well known examples of operating systems that are consistent with the principles of the present invention include Mac OS by Apple Computer, Open VMS, GNU/Linux, AIX by IBM, Java and Sun Solaris by Sun Microsystems, Windows by Microsoft Corporation, Microsoft Windows CE, Windows NT, Windows 2000, and Windows XP.

Interface 202 provides a user interface for controlling the operation of computer system 100. Interface 202 may comprise an environment or program that displays, or facilitates the display of on-screen options, usually in the form of icons and menus in response to user commands. Options provided by interface 202 may be selected by the user through the operation of hardware, such as mouse 106 and keyboard 104. These interfaces, such as the Windows Operating System, are well known in the art.

Additional application programs, such as application software 206, may be “loaded” (i.e., transferred from storage 110 into cache 112) for execution by the system 100. For example, application software 206 may comprise application, such as a word processor, spreadsheet, or database management system. Well known applications that may be used in accordance with the principles of the present invention include database management programs, such as DB2 by IBM, font and printing software, and other programming languages.

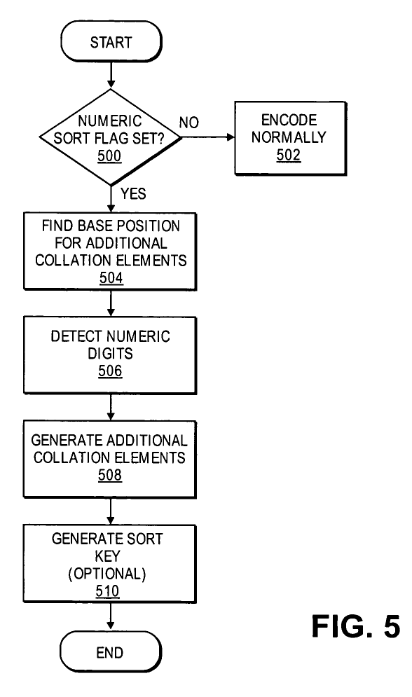

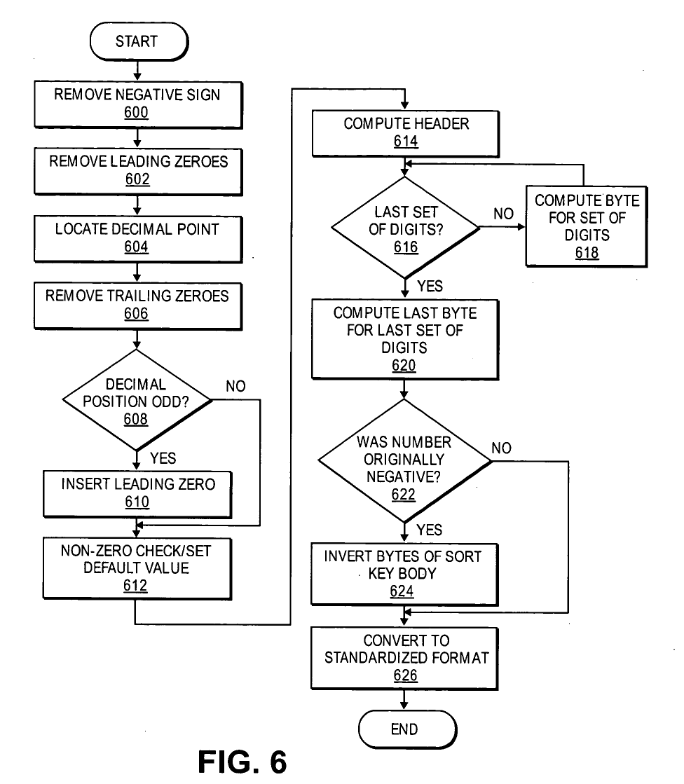

Collation engine 204 performs collation on behalf of system 100. Collation engine 204 may be implemented as a component of OS 200 or application software 206. Alternatively, collation engine 204 may be implemented as a separate module that is coupled to OS 200 or application software 206 via an application program interface. In some embodiments, collation engine 204 may be implemented as software written in a known programming language, such as C, C++, or Java. For example, in some embodiments, collation engine 204 may be implemented based on IBM's “International Components for Unicode” (“ICU”). ICU is a set of C/C++ and Java libraries for Unicode support and software internationalization and globalization. Methods used by collation engine 204 will be described with reference to FIGS. 5 and 6. Of course one skilled in the art will recognize that collation engine 204 based on a variety of products and support any number of encoding standards.

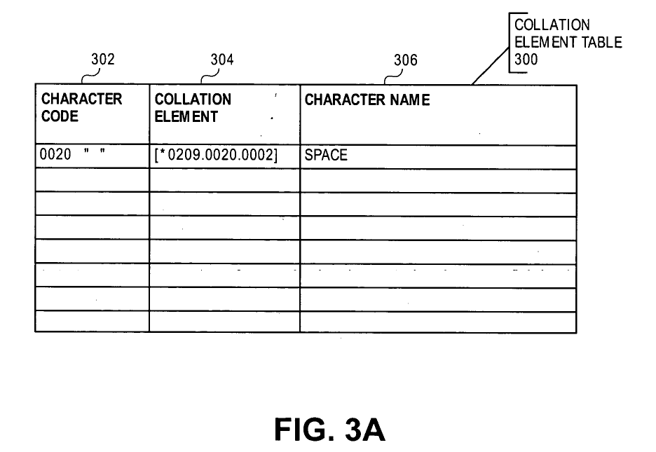

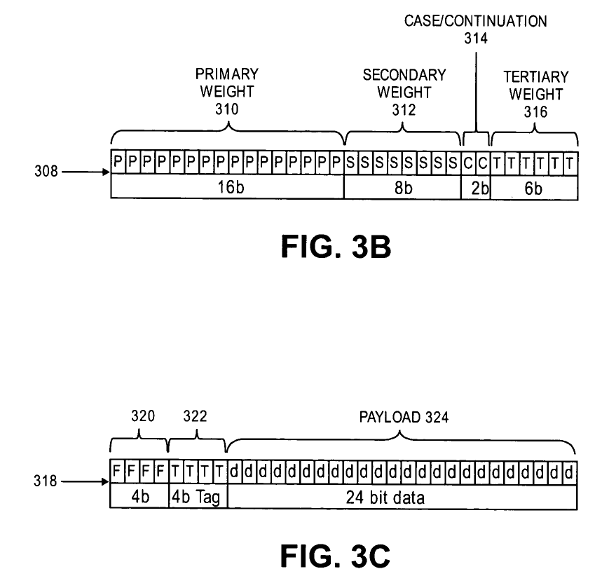

It may now be helpful to illustrate certain data structures employed by the collation engine 204. Collation engine 204 may employ a collation element table, and collation elements having multiple weight levels. In addition, collation engine 204 may optionally employ sort keys. These data structures will now be described with reference now to FIGS. 3a, 3b, and 3c.

FIG. 3a illustrates a typical collation element table 300 that is consistent with the principles of the present invention. Collation element table 300 contains a mapping from one (or more) characters to one (or more) collation elements. As shown, collation element table 300 may comprise a character code column 302 and a collation element column 304. Collation element table 300 may also optionally include a character name column 306, for example, to assist a user or programmer interpret contents of table 300. However, the contents of character name column 306 are separate from the collation elements. The mapping from characters to collation elements may map one character to one collation element, one collation element to many characters, many collation elements to one character, or from many collation elements to many characters. For example, collation element table 300 is shown with an entry for a “SPACE” character;

There are several well known standards for encoding characters. These standards include, for example, standards by the Unicode Consortium, and ISO. In some embodiments, the Unicode character set may be used. However, one skilled in the art will recognize that any standard for encoding characters may be used in accordance with the principles of the present invention.

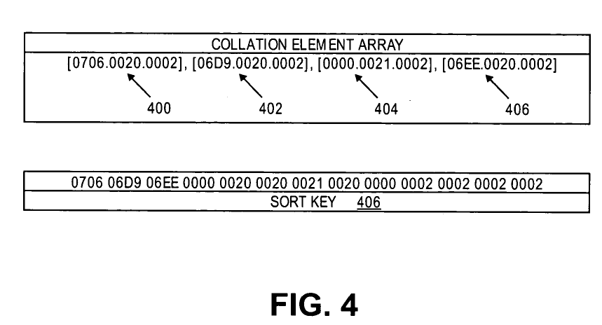

In some embodiments, collation engine 204 may perform collation based on the Unicode Collation Algorithm (“UCA”). According to the UCA, an input character string is checked against collation element table 300 to determine its respective collation elements. A sort key, such as the one illustrated in FIG. 4, may then be produced based on the collation elements of the character strings.

As explained above, in some embodiments, collation engine 204 may use multilevel Unicode collation elements, such as those illustrated in FIGS. 3b and 3c. In some embodiments, by default, collation engine 204 may use three fully-customizable levels, and thus, collation element table 300 may simply store 32-bit collation elements for each significant character. However, one skilled in the art will recognize that the present invention is not limited to supporting only the UCA or collation elements having three levels. For example, an application which uses the collation engine 204 may choose to have a fully customizable fourth level weight in the collation elements.

The various columns of collation element table 300 will now be described. In some embodiments, collation element table 300 may include the predetermined collation elements set forth in the Default Unicode Collation Element Table (“DUCET”) of the Unicode Standard. Accordingly, for ease of illustration, collation element table 300 will be explained using the UCA and Unicode standard as an explanatory example. However, one skilled in the art will recognize that collation element table 300 may include any set of predetermined collation elements from a given organization.

Character code column 302 includes the numeric codes that uniquely identify each character of a character string. In some embodiments, character code column 302 may use codes known as code points that are specified in the DUCET. As noted above, any set of character codes may be used in accordance with the principles of the present invention. Table 1 below illustrates some sample code points from the DUCET and their corresponding collation elements and names.

TABLE 1

| Character | | |
|---|---|---|
| Code | Collation Element | Character Name |
| 0030 “0” | [0A0B.0020.0002] | DIGIT ZERO |
| 2468 “9” | [0A14.0020.0006] | CIRCLED DIGIT 9 |
| 0061 “a” | [06D9.0020.0002] | LATIN SMALL LETTER A |
| 0062 “b” | [06EE.0020.0002] | LATIN SMALL LETTER B |
| 0063 “c” | [0706.0020.0002] | LATIN SMALL LETTER C |
| 0043 “C” | [0706.0020.0008] | LATIN CAPITAL LETTER C |
| 0064 “d” | [0712.0020.0002] | LATIN SMALL LETTER D |

Collation element column 304 includes the collation elements that correspond to each code point for a character. In general, a collation element is an ordered list of one or more numeric codes that indicate weights affecting how a particular character will be sorted during collation. For example, according to the Unicode standard, a collation element may be a 32-bit value that comprises one or more portions corresponding to each weight. Collation elements are also further described with reference to FIGS. 3b and 3c.

Character name column 306 includes information for identifying a particular character. Character name column 306, for example, may include information that identifies a language, the character's case, and a name for the printable natural language version of the character.

FIG. 3b illustrates a first collation element format that is consistent with the principles of the present invention. As noted above, for ease of illustration, FIG. 3b illustrates a collation element format 308 that is consistent with the Unicode standard. However, the present invention may support any format of collation element.

Referring now to FIG. 3b, first collation element format 308 may comprise a 32 bit value. As shown, the first 16 bits set forth a primary weight value 310. A secondary weight value 312 is then specified in the next 8 bits. A set of case/continuation bits 314 is specified in the following 2 bits, and a tertiary weight value 316 is specified in the last 6 bits. The weight values 310, 312, and 316 in the collation element are used to resolve a character's location in a sorting order and may be broken into multiple levels, i.e., a primary weight, secondary weight, and tertiary weight.

Primary weight value 310 represents a group of similar characters. Primary weight value 310 determines the basic sorting of the character string and takes precedence over the other weight values. For example, the primary weight values for the letters “a” and “b” or numbers “1” and “2” will be different.

Secondary weight value 312 and tertiary weight value 316 relate to other linguistic elements of the character, such as accent markings, that are important to users in ordering, but have less importance to basic sorting. In practice, not all of these levels may be needed or used, depending on the user preferences or customizations.

Case/Continuation value 314 may be used to indicate a case value for a character, or to indicate that collation element 308 continues into another collation element. When indicating a case, case/continuation value 314 can either be used as part of the case level, or considered part of tertiary weight 316. In addition, case/continuation value 314 may be inverted, thus changing whether small case characters are sorted before large case characters or vice versa.

Referring now to FIG. 3c, a second collation element format is illustrated that is consistent with the principles of the present invention. Again, for purposes of illustration, FIG. 3c illustrates another collation element format that is consistent with the Unicode standard. However, any collation element format is consistent with the principles of the present invention.

As shown, second collation element format 318 may also be a 32 bit value. Second collation element format 318 may be distinguishable from first collation element format 308 in that the header or first set of bits 320 are set to “1” (or “FF” in hexadecimal format). Second collation element format 318 may further include a 4 bit tag value 322 and a payload section 324 of 24 bits for carrying general data for encoding a character. Payload section 324 may be used to encode characters and form collation elements in a format that is distinguishable from first collation element format 308. For example, in some embodiments, second collation element format 318 may be used to form one or more additional sets of collation elements that are different from the default predetermined collation elements specified in the DUCET.

FIG. 4 illustrates a sort key that is consistent with the principles of the present invention. For purpose of illustration, FIG. 4 shows an array of collation elements 400, 402, 404, and 406 for an exemplary string of characters. Sort key 406 provides a variable length data structure for assisting in the collation of a character string. As shown, sort key 406 comprises a primary weight section 408, a first level separator 410, a secondary weight section 410, a second level separator 412, a tertiary weight section 414, and a trailer 416.

In some embodiments, collation engine 204 forms sort key 406 by successively appending weights from the array of collation element arrays for a character string into respective sections. That is, the primary weights from each collation element are appended into primary weight section; the secondary weights are appended into secondary weight section, and so on. For example, as shown in FIG. 4, collation elements 400, 402, 404, and 406 may include primary weights “0706,” “06D9,” “0000,” and “06EE,” respectively. Accordingly, collation engine 204 may form sort key 406 with a primary weight section 408 of “0706 06D9 06EE 0000.” Collation engine 204 may then insert level separator 410, such as a “00,” and append the secondary weights from collation elements 400, 402, 404, and 406, and so forth. By forming sort key 406 in this manner in some of the embodiments, collation engine 204 may thus handle any number of continuous sequences of numbers within a string.

Because database operations may be sensitive to collation speed and sort key length, in some embodiments, collation engine 204 may generate smaller length sort keys that are based on the Unicode standard. For example, collation Engine 204 may use less than all of the available levels in the collation element array. In particular, collation engine 204 may elect to ignore or not append higher level weights, such as the secondary or tertiary weights, into the sort key. Thus, by electing to ignore one or more weights from collation elements, collation engine 204 may generate shorter length sort keys. Furthermore, collation engine 204 may use one or more known compression algorithms to compress sort key 406 into a shorter length. However, any length sort key may be used in accordance with the principles of the present invention. The length of the sort key used by collation engine 204 may be based upon user preference or a configuration setting of system 100.

According to the present invention, during collation, two or more sort keys may be binary-compared to give the correct numerical comparison between the strings for which they correspond. FIG. 7 illustrates some sample sort keys that are numerically comparable, and thus, consistent with the principles of the present invention. For ease of illustration, these sort keys do not include the offset-by-5 used in some embodiments of the present invention. As shown in FIG. 7, the sort keys consistent with the principles of the present invention may be generated such that they are not sensitive to leading zeros, trailing fractional zeros, or to whether the number is positive or negative.

Alternatively, collation engine 204 may perform sorting without the use of sort keys. For example, some applications or APIs may be configured to collate or sort character strings based on direct comparison rather than sort keys. Accordingly, in some embodiments, collation engine 204 may encode character strings into bit sequences based on the data structures described above and then directly compare the bit sequences to each other to determine their order. One skilled in the art will recognize that the principles of the present invention are applicable to either type of collation.

FIG. 5 illustrates an overall process flow for processing characters in accordance with the principles of the present invention. For ease of discussion, FIG. 5 is discussed in relation to those embodiments of the present invention that are based on the Unicode Collation Algorithm (“UCA”). Based on this exemplary discussion, one skilled in the art will then recognize how the principles of the present invention may be applied to other types of collation algorithms, such as those involving ISO standards.

In stage 500, collation engine 204 determines whether a character string includes embedded numeric characters that are used for numeric sorting. Collation engine 204 may identify character strings that are to be numerically sorted based on one or more attributes associated with the character string. For example, system 100 may set one or more attributes, such as a flag that indicate the character string is to be numerically sorted. Such attributes for character strings are known to those skilled in the art and may be specified in a variety of ways. In particular, these attributes may be configured based on user preferences or configuration settings of system 100. For example, these attributes may be configured by an object oriented program, variable declaration statement, or based on configuration settings for creating a table, such as in a database.

If the character strings have not been flagged for numeric sorting, then processing flows to stage 502. In stage 502, collation engine 204 encodes the character strings based on the predetermined collation elements. For example, collation engine 204 may proceed with encoding the characters based on the predetermined collation elements that are set forth in the DUCET of the UCA.

If the character strings have been flagged for numeric sorting, then processing flows to stage 504. In stage 504, collation engine 204 determines a base position in collation element table 300 for storing an additional or customized set of collation elements that are numerically comparable. In particular, collation engine 204 searches for an open range or gap of values in collation element table 300.

For example, in the DUCET, the numeric digit “0” has a code point of 0030 and a standard collation element of [1A 90, 05, 05] # [0A0B.0020.0002], and the last digit of circled digit “9” has a code point of 2468 and a standard collation element of [1A A2, 05, 0D] # [0A14.0020.0006]. Hence, in the DUCET, there is a gap or open range up to code point 0061 for the Latin small letter “a,” which has a standard collation element of [ID, 05, 05] # [0A15.0020.0002]. As a result, collation engine 204 may consider a potential base position for collation elements at values beginning with 1 B to 1C.

Hence, collation engine 204 may determine that the entries between 1B and 1C of collation element table 300 are empty and may be used as a base position for collation elements for the character string. Collation engine 204 may work with customized collation elements that are long (or short) sequences and use second collation element format 318 as an additional set of collation elements for the character strings. In addition, collation engine 204 may work within the byte ranges for trailing bytes of a primary weight, such as 03 to FF, in order to ease encoding the character strings;
Collation engine 204 may use virtually any size for the open range or gap. For example, even an open range of one byte in collation element table 300, such as a gap between collation elements that begin with hexadecimal bytes “60” and “62”, may be sufficient as a base position. That is, collation engine 204 may use an additional set of collation elements that begin with hexadecimal byte “61.” Of course, an open range or gap of greater than one byte in length may be used by collation engine 204 as a base position for additional collation elements.

In addition, in some embodiments, stages 500, 502, and 504 may be performed as part of a preprocessing phase of system 100, i.e., those phases completed by collation engine 204 before runtime of an application like application 206. However, one skilled in the will recognize that stages 500, 502, and 504 may be performed by system 100 at other times, for example, based on considerations for efficiency or conservation of memory.

In stage 506, collation engine 204 detects the numeric digits, if any, that may be embedded within the character string. For example, collation engine 204 may detect one or more continuous sequences of digits within the string. Collation engine 204 may detect numeric digits in an efficient manner that does not impact the handling of characters other than numbers, such as letters or symbols. In particular, collation engine 204 sequentially analyzes each character of the character string, retrieves its code point and default collation element from the DUCET from collation element table 300, and determines whether its code point corresponds to a numeric digit. Collation engine 204 may then buffer the code point and collation elements of each numeric digit as they are detected.

In some embodiments, if the default collation element of the digit character is a simple 32-bit word with a common tertiary weight of “05,” collation engine 204 may create and store the primary and secondary weights in payload section 318 of second collation element format 318. Collation engine 204 may further insert within second collation element format 318 one or more marker bits or threshold value to indicate an offset.

In stage 508, collation engine 204 generates the weights and the collation element for the numeric digits in the character string. Collation engine 204 may generate a primary weight sequence as follows. Collation engine 204 may set the first byte of the weight string to be within the base position, e.g., at collation elements beginning with 1B. Collation engine 204 may then store the sign and an exponent in the next byte. In some embodiments, collation engine 204 may encode a pair of significant digits for an exponent into a byte of data. However, one skilled in the art will recognize that any format for encoding the exponent may be used.

In addition, collation engine 204 may insert a tag into the byte for an exponent to indicate whether the exponent is encoded across additional bytes. For example, collation engine 204 may set the most significant bit to “1” of the byte for the exponent to indicate that the exponent is encoded by at least one additional byte of data. In order to indicate the last byte of the exponent, collation engine 204 may also, for example, set the most significant bit to “0.”

Collation engine 204 will further encode the remaining digits in sets, such as pairs of digits, within each subsequent byte and encode them using a base 100. In order to accommodate any size of number, collation engine 204 may rely on an exponent using a base of 100. That is, the exponent for 99 is 1, while the exponent for 100 is 2, and so on.

In stage 510, collation engine 204 generates sort key 406. In some embodiments, collation engine 204 generates a single or “inline” sort key 406 that describes the character string as a whole. That is, in some embodiments, collation engine 204 may generate a sort key that incorporates both the predetermined collation elements for characters other than text and the additional collation elements for numeric digits. This allows collation engine 204 to optionally provide a single compact sort key that is still numerically comparable when desired or requested by system 100.

In general, collation engine 204 generates sort key 406 by successively appending weights from the collation element array for the character string. As explained previously, the weights from collation elements are appended from each level in turn, from primary, to secondary, and so on. Backwards weights may be inserted in reverse order.

In some embodiments, collation engine 204 may allow the maximum level to be set to a smaller level than the available levels in the collation element array. For example, if the maximum level is set to 2, then level 3 and higher weights may not be appended to sort key 406. Thus any differences at levels 3 and higher may be optionally ignored, leveling any such differences in string comparison. The character string may then be numerically sorted with other character strings based on sort key 406. The generation of sort key 406 by collation engine 204 will now be further described with reference to FIG. 6.

FIG. 6 further illustrates the process for generating a sort key that is numerically comparable in accordance with the principles of the present invention. In stage 600, collation engine 204 detects and removes any negative signs. A negative sign may be indicated in one or more attributes or flags associated with the character string. If collation engine 204 finds a negative sign in the character string, it may then set a flag to indicate that the character string specified a negative number.

In stage 602, collation engine 204 removes any leading zeros from each continuous sequence of digits. For example, if the character string were “a00010”, then collation engine 204 may convert it to “a10.” As another example, if the character string were “a0002b0004”, then collation engine 204 may convert it to “a2b4.”

In stage 604, collation engine 204 determines a scale of magnitude for each continuous sequence of numeric digits in the character string. For example, collation engine 204 may determine the scale of magnitude based on locating any decimal points. Collation engine 204 may then record its location and remove it from the character string. For example, if the character string were “10.09”, then collation engine 204 would convert the character string to “1009” and record that the decimal position was between the second and third digits of the character string, i.e., at position “3.”

In stage 606, collation engine 204 removes any trailing zeros from each continuous sequence of numeric digits. For example, if the character string were “a100.100”, then collation engine 204 would convert it to “a100.1.”

In stage 608, collation engine 204 may format the numeric digits for byte encoding. In particular, in some embodiments, collation engine 204 may attempt to encode a set, such as one or more pairs, of the numeric digits into a byte of data. By doing so, collation engine 204 may, for example, ease the processing requirements for handling the numeric digits. However, one skilled in the art will recognize that each number in a string may be encoded in a variety of formats.

Collation engine 204 may format the numeric digits based on checking whether there are an odd number of numeric digits by checking whether the decimal position was odd. If the decimal position is even, i.e., indicating an even number of numeric digits, then processing may flow directly to stage 612. However, if the decimal position is odd, then processing flows to stage 610 where collation engine 204 modifies the character string to have an even number of numeric digits. For example, collation engine 204 may add a leading “0” in front of the numeric digits, and thus, increment the decimal position to an even position, such as from position “3” to “4.” For example, if the character string were “a123b456”, then collation engine 204 may convert it to “a0123b0456.” Processing may then flow to stage 612.

In stage 612, collation engine 204 performs a non-zero check and sets the numeric value of the character string to a default value, such as “0” or “00.” In particular, collation engine 204 checks whether any numeric characters remain in the character string. If there are no numeric characters remaining in the character string, then in some embodiments collation engine 204 sets the numeric value of the character string to “00” with a decimal position of 2 (i.e., an even decimal position), and a positive sign.

In stage 614, collation engine 204 computes a lead or header value for the additional collation element such that the additional collation element does not conflict with the predetermined or default collation elements for characters other than numbers. For example, collation engine 204 may use a collation element that is formatted according to second collation element format 318. Collation engine 204 may use this format in order to minimize the amount of overhead, e.g., one byte of data, used to encode the numbers in a string. However, collation engine 204 may use any amount of overhead based on a variety of factors, such as system settings or data formatting requirements.

In some embodiments, collation engine 204 computes the first byte of payload section 424 to be calculated based on the equation of:
First byte=0×80+((decimal position/2) & 0×7F).

This equation may be based on a binary set of bits expressed in hexadecimal format and may be implemented based on known types of logic circuitry or software.

In stage 616, collation engine 204 checks whether the last set, such as the last pair, of numeric digits within a continuous sequence of digits has been encoded. If not, then processing flows to stage 618. If the last set of digits has been encoded, then processing flows directly to stage 620.

In stage 618, collation engine 204 computes a byte of the additional collation element based on a set of numeric digits. In some embodiments, collation engine 204 may convert each set of digits, e.g. a pair, to a number from 0 to 99, and then multiply it by a factor, such as the integer 2. In some embodiments, collation engine 204 may use this calculation to provide a “spread” between the byte values for pairs of digits and avoid collisions (i.e., an overlap of values) between collation elements. For example, collation engine 204 may convert an original set of numbers, such as 0, 1, 2 . . . 98, and 99, to a “doubled” set of 0, 2, 4 . . . 196, and 198. Of course, other multiplication factors may be used in accordance with the principles of the present invention.

In addition, since the current byte does not correspond to the last set of digits, collation engine 204 may also add an offset or flag to the byte value for the set of digits. That is, in some embodiment, collation engine 204 may add a “1” to the byte value. For example, continuing with the doubled set of values above of 0, 2, 4, 6, . . . 196, and 198, then if these values correspond to a non-final set of digits, collation engine 204 would convert those values to 1, 3, 5, . . . 197, and 199 respectively.

In some embodiments, collation engine 204 may use this offset or flag to indicate the length of a continuous sequence of digits in a character string. For example, the principles of the present invention support any length of character string, such as “a123,” “a123.112,” or “a1234.” In addition, the character strings may include one or more continuous sequences of numeric digits, such as “a123b456.” Processing may then loop back to stage 616.

In stage 620, collation engine 204 has identified the current set of digits as corresponding to the last set of digits in a continuous sequence, i.e., the “last” byte. In some embodiments, collation engine 204 may also convert this last byte to a number from 0 to 99, and then multiply by a factor, such as the integer 2. As noted, collation engine 204 may use this calculation to provide a “spread” between the byte values for sets of digits and avoid collisions (i.e., an overlap of values) between collation elements.

In addition, since the current byte corresponds to the last set of digits, collation engine 204 may mark this last byte as corresponding to the last set of digits in a continuous sequence. In some embodiments, collation engine 204 may mark the last byte of the last set by leaving the byte value for this set unchanged. For example, continuing with the example values above, the doubled set of values would remain 0, 2, 4 . . . 196, and 198. Accordingly, by leaving the byte value for this set unchanged, the last byte may be easily distinguishable because it is an even value, whereas the bytes for non-final sets or pairs of digits are odd values. Alternatively, collation engine 204 may add an offset or flag to the byte value to indicate its position as the last set.

In some embodiments, collation engine 204 may use this indicator in the last byte to indicate the length of a continuous sequence of digits. For example, collation engine 204 may handle character strings, such as “a123b,” “a123.112,” or “a1234.” By indicating the length of a continuous sequence of digits, collation engine 204 may ensure that a numeric sort of these characters is appropriately based on the digits and not on a mixed comparison, for example, between letters and numbers. For example, in the sample strings noted, collation engine 204 may use this last byte indicator to ensure that the “3b” of “a123b” is not compared to the “34” of “a1234.” Of course, one skilled in the art will recognize that other ways of indicating the length of a sequence of digits may be used with the present invention.

Processing now flows to stage 622. In stage 622, collation engine 204 determines whether to invert the bytes based on the sign of the number. If the sign was positive, then processing may flow directly to stage 626. If the sign was negative, then processing flows to stage 624 where collation engine 204 may perform a subtraction based on inverted each of these bytes. For example, continuing with the set of values noted above, collation engine 204 would convert a doubled set of non-final sets of numbers of 0, 2, 4, . . . 196, and 198 to 199 to an “inverted” set of 198, 196, 194, . . . 2, and 0. As another example, collation engine 204 would convert a doubled set of last set numbers of 1, 3, 5 . . . 197, and 199 to an inverted set of 199, 197, 195 . . . 3, and 1. Processing may then flow to stage 626.

Before proceeding to the discussion of stage 626, however, Table 2 is provided below to illustrate how the values for various sets of pairs of digits may be processed by collation engine 204 during stages 616 to 624. As noted above, in some embodiments, collation engine 204 may initially parse the numeric digits in a string into sets of pairs, thus resulting in possible sets of pairs that range in value from 0 to 99. Collation engine 204 may then process or modify the value for each pair of numeric digits based on it relative position within a string and sign as shown below.

TABLE 2

| | | | | | | |
|---|---|---|---|---|---|---|
| Original Value of Pair of Digits | 0 | 1 | 2 | . . . | 98 | 99 |
| After Doubling | 0 | 2 | 4 | . . . | 196 | 198 |
| Positive and Non-Last Pair | 1 | 3 | 5 | . . . | 197 | 199 |
| Positive and | 0 | 2 | 4 | . . . | 196 | 198 |
| Last Pair | | | | | | |
| (Last Byte) | | | | | | |
| Negative and Non-Last Pair | 198 | 196 | 194 | . . . | 2 | 0 |
| Negative and Last Pair | 199 | 197 | 195 | . . . | 3 | 1 |
| (Last Byte) | | | | | | |

In stage 626, collation engine 204 completes formatting of sort key 406. For example, in some embodiments, collation engine 204 may add an offset to each byte of the collation element. In particular, for those embodiments that are consistent with the ICU, collation engine 204 may add “5” to each byte to create an offset that avoids collisions with certain reserved values. For example, adding a “5” ensures that each portion of the additional collation element does not collide or interfere with level separators used by sort key 406. Continuing with the examples noted above, Table 3 below illustrates how collation engine 204 may modify the values for each set of digits in various cases.

TABLE 3

| | | | | | | |
|---|---|---|---|---|---|---|
| Positive and Non-Last Pair | 6 | 8 | 10 | . . . | 202 | 204 |
| (with offset of 5) | | | | | | |
| Positive and | 5 | 7 | 9 | . . . | 201 | 203 |
| Last Pair | | | | | | |
| (Last Byte and with offset of 5) | | | | | | |
| Negative and Non-Last Pair | 203 | 201 | 199 | . . . | 7 | 5 |
| (with offset of 5) | | | | | | |
| Negative and Last Pair | 204 | 202 | 200 | . . . | 8 | 6 |
| (Last Byte and with offset of 5) | | | | | | |

Sort key 406 may then be stored, for example, by processor 102 in cache 112 or memory 104 for later use during a numeric sort or collation. The results of the sort may then be provided to the user by system 100, for example via display 108.

During collation, collation engine 204 may retrieve the sort keys from cache 112 or memory 104. Collation engine 204 may then compare the sort keys to obtain a numerical comparison between the strings for which they correspond. The following Table 4 illustrates some sample sort keys that are numerically comparable in accordance with the principles of the present invention. For ease of illustration, these sort keys do not include the offset-by-5 used in some embodiments of the present invention.

As shown in Table 4 below, the sort keys consistent with the principles of the present invention may be generated such that they are not sensitive to leading zeros, trailing fractional zeros, or to whether the number is positive or negative.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims. For example, one skilled in the art will recognize that the principles of the present invention are applicable to sorting or collation that relies on direct comparison in addition to sorting based on sort keys. In particular, when character strings are received, collation engine 204 may convert strings into respective bit sequences based on retrieving the predetermined collation elements and the additional set of collation elements from collation element table 300. However, instead of generating a sort key for each of the strings, collation engine 204 may sort the character strings by directly comparing one or more portions of their respective bit sequences.

TABLE 4

| Number | Sort Key |
|---|---|
| −0100000001.1 | 7A.FC.FE.FE.FE.FC.EB |
| −100000001.1 | 7A.FC.FE.FE.FE.FC.EB |
| −100000001.10 | 7A.FC.FE.FE.FE.FC.EB |
| −0100000001.10 | 7A.FC.FE.FE.FE.FC.EB |
| −0100000001. | 7A.FC.FE.FE.FE.FD |
| −100000001. | 7A.FC.FE.FE.FE.FD |
| −100000001.0 | 7A.FC.FE.FE.FE.FD |
| −0100000001 | 7A.FC.FE.FE.FE.FD |
| −0100000001.0 | 7A.FC.FE.FE.FE.FD |
| −100000001 | 7A.FC.FE.FE.FE.FD |
| −0100000000.10 | 7A.FC.FE.FE.FE.FE.EB |
| −100000000.10 | 7A.FC.FE.FE.FE.FE.EB |
| −100000000.1 | 7A.FC.FE.FE.FE.FE.EB |
| −0100000000.1 | 7A.FC.FE.FE.FE.FE.EB |
| −0100000000 | 7A.FD |
| −100000000. | 7A.FD |
| −0100000000. | 7A.FD |
| −100000000 | 7A.FD |
| −100000000.0 | 7A.FD |
| −0100000000.0 | 7A.FD |
| −099999999.9 | 7B.38.38.38.38.4B |
| −99999999.90 | 7B.38.38.38.38.4B |
| −99999999.9 | 7B.38.38.38.38.4B |
| −099999999.90 | 7B.38.38.38.38.4B |
| −099999999 | 7B.38.38.38.39 |
| −99999999. | 7B.38.38.38.39 |
| −99999999 | 7B.38.38.38.39 |
| −099999999. | 7B.38.38.38.39 |
| −99999999.0 | 7B.38.38.38.39 |
| −099999999.0 | 7B.38.38.38.39 |
| −099999998.9 | 7B.38.38.38.3A.4B |
| −99999998.90 | 7B.38.38.38.3A.4B |
| −99999998.9 | 7B.38.38.38.3A.4B |
| −099999998.90 | 7B.38.38.38.3A.4B |
| −1001.10 | 7D.EA.FC.EB |
| −1001.1 | 7D.EA.FC.EB |
| −01001.1 | 7D.EA.FC.EB |
| −01001.10 | 7D.EA.FC.EB |
| −01001.0 | 7D.EA.FD |
| −1001 | 7D.EA.FD |
| −1001. | 7D.EA.FD |
| −01001. | 7D.EA.FD |
| −01001 | 7D.EA.FD |
| −1001.0 | 7D.EA.FD |
| −1000.1 | 7D.EA.FE.EB |
| −01000.10 | 7D.EA.FE.EB |
| −01000.1 | 7D.EA.FE.EB |
| −1000.10 | 7D.EA.FE.EB |
| −1000. | 7D.EB |
| −1000.0 | 7D.EB |
| −01000. | 7D.EB |
| −01000.0 | 7D.EB |
| −1000 | 7D.EB |
| −01000 | 7D.EB |
| −999.90 | 7D.EC.38.4B |
| −0999.9 | 7D.EC.38.4B |
| −0999.90 | 7D.EC.38.4B |
| −999.9 | 7D.EC.38.4B |
| −999.0 | 7D.EC.39 |
| −0999.0 | 7D.EC.39 |
| −999 | 7D.EC.39 |
| −0999 | 7D.EC.39 |
| −0999. | 7D.EC.39 |
| −999. | 7D.EC.39 |
| −0998.9 | 7D.EC.3A.4B |
| −0998.90 | 7D.EC.3A.4B |
| −998.9 | 7D.EC.3A.4B |
| −998.90 | 7D.EC.3A.4B |
| −0101.1 | 7D.FC.FC.EB |
| −101.10 | 7D.FC.FC.EB |
| −101.1 | 7D.FC.FC.EB |
| −0101.10 | 7D.FC.FC.EB |
| −0101.0 | 7D.FC.FD |
| −0101. | 7D.FC.FD |
| −101 | 7D.FC.FD |
| −101. | 7D.FC.FD |
| −101.0 | 7D.FC.FD |
| −0101 | 7D.FC.FD |
| −100.10 | 7D.FC.FE.EB |
| −100.1 | 7D.FC.FE.EB |
| −0100.1 | 7D.FC.FE.EB |
| −0100.10 | 7D.FC.FE.EB |
| −0100.0 | 7D.FD |
| −100. | 7D.FD |
| −0100 | 7D.FD |
| −100 | 7D.FD |
| −0100. | 7D.FD |
| −100.0 | 7D.FD |
| −99.90 | 7E.38.4B |
| −99.9 | 7E.38.4B |
| −099.90 | 7E.38.4B |
| −099.9 | 7E.38.4B |
| −99. | 7E.39 |
| −99 | 7E.39 |
| −099. | 7E.39 |
| −099.0 | 7E.39 |
| −099 | 7E.39 |
| −99.0 | 7E.39 |
| −098.9 | 7E.3A.4B |
| −098.90 | 7E.3A.4B |
| −98.9 | 7E.3A.4B |
| −98.90 | 7E.3A.4B |
| −051.10 | 7E.98.EB |
| −51.10 | 7E.98.EB |
| −51.1 | 7E.98.EB |
| −051.1 | 7E.98.EB |
| −51. | 7E.99 |
| −051. | 7E.99 |
| −51 | 7E.99 |
| −051 | 7E.99 |
| −051.0 | 7E.99 |
| −51.0 | 7E.99 |
| −50.10 | 7E.9A.EB |
| −050.1 | 7E.9A.EB |
| −050.10 | 7E.9A.EB |
| −50.1 | 7E.9A.EB |
| −50 | 7E.9B |
| −50. | 7E.9B |
| −50.0 | 7E.9B |
| −050.0 | 7E.9B |
| −050. | 7E.9B |
| −050 | 7E.9B |
| −49.90 | 7E.9C.4B |
| −49.9 | 7E.9C.4B |
| −049.90 | 7E.9C.4B |
| −049.9 | 7E.9C.4B |
| −49.0 | 7E.9D |
| −049.0 | 7E.9D |
| −049. | 7E.9D |
| −49 | 7E.9D |
| −049 | 7E.9D |
| −49. | 7E.9D |
| −48.90 | 7E.9E.4B |
| −048.90 | 7E.9E.4B |
| −48.9 | 7E.9E.4B |
| −048.9 | 7E.9E.4B |
| −011.10 | 7E.E8.EB |
| −11.10 | 7E.E8.EB |
| −011.1 | 7E.E8.EB |
| −11.1 | 7E.E8.EB |
| −011. | 7E.E9 |
| −011.0 | 7E.E9 |
| −11 | 7E.E9 |
| −11.0 | 7E.E9 |
| −11. | 7E.E9 |
| −011 | 7E.E9 |
| −010.1 | 7E.EA.EB |
| −10.10 | 7E.EA.EB |
| −10.1 | 7E.EA.EB |
| −010.10 | 7E.EA.EB |
| −010.0 | 7E.EB |
| −10.0 | 7E.EB |
| −10 | 7E.EB |
| −010 | 7E.EB |
| −010. | 7E.EB |
| −10. | 7E.EB |
| −09.9 | 7E.EC.4B |
| −9.9 | 7E.EC.4B |
| −09.90 | 7E.EC.4B |
| −9.90 | 7E.EC.4B |
| −9.0 | 7E.ED |
| −9. | 7E.ED |
| −09.0 | 7E.ED |
| −09. | 7E.ED |
| −09 | 7E.ED |
| −9 | 7E.ED |
| −8.90 | 7E.EE.4B |
| −8.9 | 7E.EE.4B |
| −08.9 | 7E.EE.4B |
| −08.90 | 7E.EE.4B |
| −06.1 | 7E.F2.EB |
| −06.10 | 7E.F2.EB |
| −6.10 | 7E.F2.EB |
| −6.1 | 7E.F2.EB |
| −6 | 7E.F3 |
| −6. | 7E.F3 |
| −06.0 | 7E.F3 |
| −6.0 | 7E.F3 |
| −06 | 7E.F3 |
| −06. | 7E.F3 |
| −05.10 | 7E.F4.EB |
| −05.1 | 7E.F4.EB |
| −5.1 | 7E.F4.EB |
| −5.10 | 7E.F4.EB |
| −5.0 | 7E.F5 |
| −5 | 7E.F5 |
| −5. | 7E.F5 |
| −05.0 | 7E.F5 |
| −05 | 7E.F5 |
| −05. | 7E.F5 |
| −4.9 | 7E.F6.4B |
| −04.9 | 7E.F6.4B |
| −04.90 | 7E.F6.4B |
| −4.90 | 7E.F6.4B |
| −04.0 | 7E.F7 |
| −04. | 7E.F7 |
| −4 | 7E.F7 |
| −4. | 7E.F7 |
| −04 | 7E.F7 |
| −4.0 | 7E.F7 |
| −03.9 | 7E.F8.4B |
| −3.9 | 7E.F8.4B |
| −03.90 | 7E.F8.4B |
| −3.90 | 7E.F8.4B |
| −01.1010 | 7E.FC.EA.EB |
| −1.101 | 7E.FC.EA.EB |
| −01.101 | 7E.FC.EA.EB |
| −1.1010 | 7E.FC.EA.EB |
| −1.1 | 7E.FC.EB |
| −01.1 | 7E.FC.EB |
| −1.1 | 7E.FC.EB |
| −01.10 | 7E.FC.EB |
| −1.10 | 7E.FC.EB |
| −01.10 | 7E.FC.EB |
| −01.1 | 7E.FC.EB |
| −1.10 | 7E.FC.EB |
| −01.001 | 7E.FC.FE.EB |
| −1.0010 | 7E.FC.FE.EB |
| −01.0010 | 7E.FC.FE.EB |
| −1.001 | 7E.FC.FE.EB |
| −01 | 7E.FD |
| −01.0 | 7E.FD |
| −1.0 | 7E.FD |
| −01.0 | 7E.FD |
| −01. | 7E.FD |
| −1.0 | 7E.FD |
| −1. | 7E.FD |
| −1 | 7E.FD |
| −01. | 7E.FD |
| −1. | 7E.FD |
| −01 | 7E.FD |
| −1 | 7E.FD |
| −00.101 | 7F.EA.EB |
| −0.1010 | 7F.EA.EB |
| −00.1010 | 7F.EA.EB |
| −0.101 | 7F.EA.EB |
| −0.1 | 7F.EB |
| −00.1 | 7F.EB |
| −0.10 | 7F.EB |
| −00.1 | 7F.EB |
| −0.10 | 7F.EB |
| −00.10 | 7F.EB |
| −00.10 | 7F.EB |
| −0.1 | 7F.EB |
| −00.0010 | 7F.FE.EB |
| −00.00 1 | 7F.FE.EB |
| −0.001 | 7F.FEEB |
| −0.0010 | 7F.FE.EB |
| 0. | 80.00 |
| 0.0 | 80.00 |
| −00 | 80.00 |
| 00.0 | 80.00 |
| 0 | 80.00 |
| −00.0 | 80.00 |
| 00.0 | 80.00 |
| 0 | 80.00 |
| 00. | 80.00 |
| −0.0 | 80.00 |
| −00. | 80.00 |
| 0.0 | 80.00 |
| −0.0 | 80.00 |
| 00 | 80.00 |
| −00. | 80.00 |
| −00.0 | 80.00 |
| −0. | 80.00 |
| 00 | 80.00 |
| −0 | 80.00 |
| −0 | 80.00 |
| 0. | 80.00 |
| −0. | 80.00 |
| 00. | 80.00 |
| −00 | 80.00 |
| 00.001 | 80.01.14 |
| 00.0010 | 80.01.14 |
| 0.001 | 80.01.14 |
| 0.0010 | 80.01.14 |
| 00.1 | 80.14 |
| 00.10 | 80.14 |
| 0.10 | 80.14 |
| 0.10 | 80.14 |
| 0.1 | 80.14 |
| 00.1 | 80.14 |
| 0.1 | 80.14 |
| 00.10 | 80.14 |
| 00.1010 | 80.15.14 |
| 0.101 | 80.15.14 |
| 0.1010 | 80.15.14 |
| 00.101 | 80.15.14 |
| 1.0 | 81.02 |
| 01. | 81.02 |
| 1. | 81.02 |
| 01. | 81.02 |
| 01.0 | 81.02 |
| 1. | 81.02 |
| 01 | 81.02 |
| 01 | 81.02 |
| 1 | 81.02 |
| 1.0 | 81.02 |
| 1 | 81.02 |
| 01.0 | 81.02 |
| 1.0010 | 81.03.01.14 |
| 01.001 | 81.03.01.14 |
| 1.001 | 81.03.01.14 |
| 01.0010 | 81.03.01.14 |
| 1.10 | 81.03.14 |
| 1.1 | 81.03.14 |
| 01.10 | 81.03.14 |
| 1.1 | 81.03.14 |
| 01.10 | 81.03.14 |
| 01.1 | 81.03.14 |
| 1.10 | 81.03.14 |
| 01.1 | 81.03.14 |
| 1.101 | 81.03.15.14 |
| 1.1010 | 81.03.15.14 |
| 01.1010 | 81.03.15.14 |
| 01.101 | 81.03.15.14 |
| 3.90 | 81.07.B4 |
| 3.9 | 81.07.B4 |
| 03.9 | 81.07.B4 |
| 03.90 | 81.07.B4 |
| 4. | 81.08 |
| 04. | 81.08 |
| 04.0 | 81.08 |
| 4.0 | 81.08 |
| 04 | 81.08 |
| 4 | 81.08 |
| 4.90 | 81.09.B4 |
| 4.9 | 81.09.B4 |
| 04.90 | 81.09.B4 |
| 04.9 | 81.09.B4 |
| 5. | 81.0A |
| 5.0 | 81.0A |
| 5 | 81.0A |
| 05 | 81.0A |
| 05. | 81.0A |
| 05.0 | 81.0A |
| 5.1 | 81.0B.14 |
| 05.1 | 81.0B.14 |
| 05.10 | 81.0B.14 |
| 5.10 | 81.0B.14 |
| 6.0 | 81.0C |
| 06 | 81.0C |
| 06.0 | 81.0C |
| 06. | 81.0C |
| 6. | 81.0C |
| 6 | 81.0C |
| 6.10 | 81.0D.14 |
| 06.10 | 81.0D.14 |
| 06.1 | 81.0D.14 |
| 6.1 | 81.0D.14 |
| 8.90 | 81.11.B4 |
| 08.90 | 81.11.B4 |
| 08.9 | 81.11.B4 |
| 8.9 | 81.11.B4 |
| 09. | 81.12 |
| 09 | 81.12 |
| 9.0 | 81.12 |
| 09.0 | 81.12 |
| 9. | 81.12 |
| 9 | 81.12 |
| 9.9 | 81.13.B4 |
| 9.90 | 81.13.B4 |
| 09.9 | 81.13.B4 |
| 09.90 | 81.13.B4 |
| 010 | 81.14 |
| 10.0 | 81.14 |
| 010. | 81.14 |
| 10 | 81.14 |
| 10. | 81.14 |
| 010.0 | 81.14 |
| 010.1 | 81.15.14 |
| 10.1 | 81.15.14 |
| 010.10 | 81.15.14 |
| 10.10 | 81.15.14 |
| 11.0 | 81.16 |
| 011 | 81.16 |
| 011. | 81.16 |
| 11. | 81.16 |
| 11 | 81.16 |
| 011.0 | 81.16 |
| 11.1 | 81.17.14 |
| 11.10 | 81.17.14 |
| 011.10 | 81.17.14 |
| 011.1 | 81.17.14 |
| 48.90 | 81.61.B4 |
| 048.9 | 81.61.B4 |
| 048.90 | 81.61.B4 |
| 48.9 | 81.61.B4 |
| 049 | 81.62 |
| 49 | 81.62 |
| 049. | 81.62 |
| 49.0 | 81.62 |
| 49. | 81.62 |
| 049.0 | 81.62 |
| 049.9 | 81.63.B4 |
| 49.9 | 81.63.B4 |
| 49.90 | 81.63.B4 |
| 049.90 | 81.63.B4 |
| 50.0 | 81.64 |
| 050.0 | 81.64 |
| 050 | 81.64 |
| 50 | 81.64 |
| 050. | 81.64 |
| 50. | 81.64 |
| 050.10 | 81.65.14 |
| 50.1 | 81.65.14 |
| 050.1 | 81.65.14 |
| 50.10 | 81.65.14 |
| 051.0 | 81.66 |
| 51.0 | 81.66 |
| 51. | 81.66 |
| 51 | 81.66 |
| 051 | 81.66 |
| 051. | 81.66 |
| 051.1 | 81.67.14 |
| 51.10 | 81.67.14 |
| 51.1 | 81.67.14 |
| 051.10 | 81.67.14 |
| 98.9 | 81.C5.B4 |
| 98.90 | 81.C5.B4 |
| 098.90 | 81.C5.B4 |
| 098.9 | 81.C5.B4 |
| 99. | 81.C6 |
| 99.0 | 81.C6 |
| 099. | 81.C6 |
| 99 | 81.C6 |
| 099 | 81.C6 |
| 099.0 | 81.C6 |
| 099.9 | 81.C7.B4 |
| 099.90 | 81.C7.B4 |
| 99.9 | 81.C7.B4 |
| 99.90 | 81.C7.B4 |
| 100.0 | 82.02 |
| 100 | 82.02 |
| 100. | 82.02 |
| 0100. | 82.02 |
| 0100.0 | 82.02 |
| 0100 | 82.02 |
| 100.10 | 82.03.01.14 |
| 100.1 | 82.03.01.14 |
| 0100.1 | 82.03.01.14 |
| 0100.10 | 82.03.01.14 |
| 0101. | 82.03.02 |
| 101.0 | 82.03.02 |
| 101 | 82.03.02 |
| 101. | 82.03.02 |
| 0101.0 | 82.03.02 |
| 0101 | 82.03.02 |
| 0101.1 | 82.03.03.14 |
| 0101.10 | 82.03.03.14 |
| 101.10 | 82.03.03.14 |
| 101.1 | 82.03.03.14 |
| 998.90 | 82.13.C5.B4 |
| 0998.9 | 82.13.C5.B4 |
| 998.9 | 82.13.C5.B4 |
| 0998.90 | 82.13.C5.B4 |
| 999 | 82.13.C6 |
| 999. | 82.13.C6 |
| 999.0 | 82.13.C6 |
| 0999. | 82.13.C6 |
| 0999 | 82.13.C6 |
| 0999.0 | 82.13.C6 |
| 0999.9 | 82.13.C7.B4 |
| 999.9 | 82.13.C7.B4 |
| 999.90 | 82.13.C7.B4 |
| 0999.90 | 82.13.C7.B4 |
| 01000 | 82.14 |
| 01000. | 82.14 |
| 1000. | 82.14 |
| 1000 | 82.14 |
| 01000.0 | 82.14 |
| 1000.0 | 82.14 |
| 1000.10 | 82.15.01.14 |
| 01000.1 | 82.15.01.14 |
| 01000.10 | 82.15.01.14 |
| 1000.1 | 82.15.01.14 |
| 1001 | 82.15.02 |
| 1001. | 82.15.02 |
| 01001.0 | 82.15.02 |
| 01001 | 82.15.02 |
| 1001.0 | 82.15.02 |
| 01001. | 82.15.02 |
| 1001.1 | 82.15.03.14 |
| 1001.10 | 82.15.03.14 |
| 01001.10 | 82.15.03.14 |
| 01001.1 | 82.15.03.14 |
| 99999998.90 | 84.C7.C7.C7.C5.B4 |
| 99999998.9 | 84.C7.C7.C7.C5.B4 |
| 099999998.90 | 84.C7.C7.C7.C5.B4 |
| 099999998.9 | 84.C7.C7.C7.C5.B4 |
| 099999999 | 84.C7.C7.C7.C6 |
| 099999999. | 84.C7.C7.C7.C6 |
| 099999999.0 | 84.C7.C7.C7.C6 |
| 99999999. | 84.C7.C7.C7.C6 |
| 99999999.0 | 84.C7.C7.C7.C6 |
| 99999999 | 84.C7.C7.C7.C6 |
| 99999999.90 | 84.C7.C7.C7.C7.B4 |
| 099999999.9 | 84.C7.C7.C7.C7.B4 |
| 99999999.9 | 84.C7.C7.C7.C7.B4 |
| 099999999.90 | 84.C7.C7.C7.C7.B4 |
| 0100000000 | 85.02 |
| 100000000.0 | 85.02 |
| 100000000. | 85.02 |
| 0100000000. | 85.02 |
| 100000000 | 85.02 |
| 0100000000.0 | 85.02 |
| 100000000.10 | 85.03.01.01.01.01.14 |
| 0100000000.1 | 85.03.01.01.01.01.14 |
| 0100000000.10 | 85.03.01.01.01.01.14 |
| 100000000.1 | 85.03.01.01.01.01.14 |
| 00000001 | 85.03.01.01.01.02 |
| 100000001. | 85.03.01.01.01.02 |
| 0100000001 | 85.03.01.01.01.02 |
| 0100000001. | 85.03.01.01.01.02 |
| 100000001.0 | 85.03.01.01.01.02 |
| 0100000001.0 | 85.03.01.01.01.02 |
| 100000001.1 | 85.03.01.01.01.03.14 |
| 0100000001.10 | 85.03.01.01.01.03.14 |
| 100000001.10 | 85.03.01.01.01.03.14 |
| 0100000001.1 | 85.03.01.01.01.03.14 |

1. A method of processing characters based on at least one attribute, wherein the characters are encoded based on one or more sets of predetermined collation elements, said method comprising:
receiving a string that includes a sequence of characters;
determining whether at least one attribute for the string indicates numeric ordering;
locating an open range of values within the sets of predetermined collation elements;
identifying a first set collation elements for characters other than numbers in the sequence based on the predetermined collation elements;
identifying one or more numbers in the string;
determining, for the numbers identified in the string, an additional set of collation elements having respective sets of weight values based on the location of the open range; and
determining a key for the sequence that is numerically comparable based on the first set of collation elements for the characters other than numbers and the additional set of collation elements for the numbers.

2. The method of claim 1, wherein determining whether the at least one attribute indicates numeric ordering comprises reading at least one flag that has been associated with the string.

3. The method of claim 1, wherein locating an open range within the sets of predetermined collation elements comprises:
reading a table that includes entries for the predetermined collation elements;
identifying a first entry in the table that corresponds to a number;
identifying a second entry in the table that corresponds to a character other than a number; and
calculating a range of values for the additional set of collation elements that is between the first and second entries.

4. The method of claim 1, wherein determining, for the identified numbers, the additional set of collation elements having respective sets of weight values comprises:
determining a sign associated with the numbers;
removing leading zeroes from the numbers;
determining a scale of magnitude for the numbers;
removing trailing zeroes from the numbers;
selectively inserting at least one leading zero based on the scale of magnitude;
calculating a first portion of the additional set of collation elements based on the scale of magnitude and the location of the open range within the predetermined collation elements;
calculating a second portion of the additional set of collation elements based on respective weight values for the numbers and the sign associated with the numbers that results in a correct ordering for positive and negative numbers;
identifying when a continuous sequence of numbers in the string has ended; and
tagging a part of the second portion to indicate a distinction between the sequence of numbers in the string and characters other than numbers in the string.

5. The method of claim 4, wherein determining the scale of magnitude for the numbers comprises locating a decimal point within the numbers.

6. The method of claim 4, wherein calculating the second portion of the additional set of collation elements based on respective weight values for the numbers comprises:
identifying a continuous sequence of numbers in the string;
selecting a set of numbers in the continuous sequence of numbers;
calculating a weight value for each set of numbers based on multiplying each set of numbers by an integer factor;
identifying a last set of numbers in the continuous sequence of numbers;
calculating a weight value for the last set; and
tagging the weight value of the last set.

7. The method of claim 1, further comprising:
numerically sorting the string in comparison to at least one additional string based on the key and when the at least one attribute indicates numeric ordering.

8. The method of claim 1, wherein identifying the first set collation elements for characters that are other than numbers in the string based on the predetermined collation elements comprises identifying Unicode-compliant collation elements for the characters other than numbers in the string.

9. The method of claim 1, wherein the sequence of characters includes at least one continuous sequence of numbers having an arbitrary numeric value, and wherein determining the key for the sequence comprises:
determining a scale of magnitude and sequence of significant digits that reflect the numeric value of the at least one continuous sequence; and
generating portions of the key to reflect the scale of magnitude and sequence of significant digits, wherein the portions that indicate the scale of magnitude and sequence of significant digits have unconstrained length and precision.

10. The method of claim 1, wherein the sequence of characters includes at least one continuous sequence of numbers having a sign, and wherein determining the key for the sequence comprises:
identifying the sign associated with the at least one sequence of numbers; and
generating portions of the key to reflect the sign of the at least one sequence of numbers.

11. The method of claim 1, wherein the sequence of characters includes at least one continuous sequence of numbers having an arbitrary-length integer component and optional arbitrary-length fractional component, and wherein determining the key for the sequence comprises:
determining a scale of magnitude for the at least one continuous sequence of numbers based on the integer component and the fractional component;
identifying significant digits of the integer component and the fractional component; and
generating portions of the key to reflect the scale of magnitude and the significant digits.

12. A method of collating strings of characters based on at least one attribute, wherein characters other than numbers are converted into bit sequences based on one or more sets of predetermined collation elements and numeric characters are converted into bit sequences based on an additional set of collation elements that is interleaved within one or more gaps in the sets of predetermined collation elements, said method comprising:
receiving a first and a second string of characters;
determining whether at least one attribute for the first and second strings indicates numeric ordering;
converting the first and second strings into respective bit sequences based on the predetermined collation elements and the additional set of collation elements when the at least one attribute indicates numeric ordering; and
numerically sorting the first and second strings of characters based on at least a portion of the bit sequences.

13. The method of claim 12, wherein the predetermined collation elements and additional set of collation elements comprise an array of weight values that indicate levels of linguistic significance, and wherein numerically sorting the first and second strings of characters based on at least a portion of the bit sequences comprises:
comparing corresponding portions of the bit sequences;
identifying a difference in a primary level of linguistic significance between the portions of the bit sequences; and
sorting the first and second strings of characters based on the primary level difference.

14. The method of claim 12, wherein the predetermined collation elements and additional set of collation elements comprise an array of weight values that indicate a level of linguistic significance, and wherein numerically sorting the first and second strings of characters further comprises:
comparing corresponding portions of the bit sequences;
determining when the bit sequences fail to differ by a first level of linguistic significance;
identifying at least one difference at a second level of linguistic significance between the portions of the bit sequences; and
sorting the strings based on the at least one difference at the second level.

15. The method of claim 12, wherein the first and second strings include at least one continuous sequence of numbers having an arbitrary numeric value, and wherein converting the first and second strings into respective bit sequences comprises:
determining a scale of magnitude and sequence of significant digits that reflect the numeric value of the at least one continuous sequence; and
generating portions of the respective bit sequences to reflect the scale of magnitude and sequence of significant digits, wherein the portions that indicate the scale of magnitude and sequence of significant digits have unconstrained length and precision.

16. The method of claim 12, wherein the first and second strings include at least one continuous sequence of numbers having an arbitrary numeric value, and wherein converting the first and second strings into respective bit sequences comprises:
identifying the signs associated with the at least one sequence of numbers; and
generating portions of the respective bit sequences to reflect the sign of the at least one sequence of numbers.

17. The method of claim 12, wherein the first and second strings include at least one continuous sequence of numbers having an arbitrary-length integer component and optional arbitrary-length fractional component, and wherein converting the first and second strings into respective bit sequences comprises:
determining a scale of magnitude for the at least one continuous sequence of numbers based on the integer component and the fractional component;
identifying significant digits of the integer component and the fractional component; and
generating portions of the respective bit sequences to reflect the scale of magnitude and the significant digits.

18. An apparatus for processing characters based on at least one attribute, wherein the characters are encoded based on one or more sets of predetermined collation elements, said apparatus comprising:
means for receiving a string that includes a sequence of characters;
means for determining whether at least one attribute for the string indicates numeric ordering;
means for locating an open range of values within the sets of predetermined collation elements;
means for identifying a first set collation elements for characters other than numbers in the string based on the predetermined collation elements;
means for identifying one or more numbers in the string;
means for determining, for the numbers identified in the string, an additional set of collation elements having respective sets of weight values based on the location of the open range; and
means for determining a key for the string that is numerically comparable based on the first set of collation elements for the characters other than numbers and the additional set of collation elements for the numbers.

19. An apparatus for collating strings of characters based on at least one attribute, wherein characters other than numbers are converted into bit sequences based on one or more sets of predetermined collation elements and numeric characters are converted into bit sequences based on an additional set of collation elements that is interleaved within one or more gaps in the sets of predetermined collation elements, said apparatus comprising:
means for receiving a first and a second string of characters;
means for determining whether at least one attribute for the first and second strings indicate numeric ordering;
means for converting the first and second strings into respective bit sequences based on the predetermined collation elements and the additional set of collation elements when the at least one attribute indicates numeric ordering;
means for comparing at least a portion of the bit sequences for the first and second strings; and
means for numerically sorting the first and second strings of characters based on the comparison of the bit sequences.

20. A computer readable medium having program code for configuring a processor to handle characters based on at least one attribute, wherein the characters are encoded based on one or more sets of predetermined collation elements, said medium comprising:
program code for receiving a string that includes a sequence of characters;
program code for determining whether at least one attribute for the string indicates numeric ordering;
program code for locating an open range of values within the sets of predetermined collation elements;
program code for identifying a first set collation elements for characters other than numbers in the string based on the predetermined collation elements;
program code for identifying one or more numbers in the string;
program code for determining, for the numbers identified in the string, an additional set of collation elements having respective sets of weight values based on the location of the open range; and
program code for determining a key for the string that is numerically comparable based on the first set of collation elements for the characters other than numbers and the additional set of collation elements for the numbers.

21. The medium of claim 20, wherein the program code for determining whether the at least one attribute indicates numeric ordering comprises program code for reading at least one flag that has been associated with the string.

22. The medium of claim 20, wherein the program code for locating an open range within the sets of predetermined collation elements comprises:
program code for reading a table that includes entries for the predetermined collation elements;
program code for identifying a first entry in the table that corresponds to a number;
program code for identifying a second entry in the table that corresponds to a character other than a number; and
program code for calculating a range of values for the additional set of collation elements that is between the first and second entries.

23. The medium of claim 20, wherein the program code for determining, for the identified numbers, the additional set of collation elements having respective sets of weight values comprises:
program code for determining a sign associated with the numbers;
program code for removing leading zeroes from the numbers;
program code for determining a scale of magnitude for the numbers;
program code for removing trailing zeroes from the numbers;
program code selectively inserting at least one leading zero based on the scale of magnitude;
program code for calculating a first portion of the additional set of collation elements based on the scale of magnitude and the location of the open range within the predetermined collation elements;
program code for calculating a second portion of the additional set of collation elements based on respective weight values for the numbers and the sign associated with the numbers that results in a correct ordering for positive and negative numbers;
program code for identifying when a continuous sequence of numbers in the string has ended; and
program code for tagging a part of the second portion to indicate a distinction between the sequence of numbers in the string and characters other than numbers in the string.

24. The medium of claim 23, wherein the program code for determining the scale of magnitude for the numbers comprises program code for locating a decimal point within the numbers.

25. The medium of claim 23, wherein the program code for calculating the second portion of the additional set of collation elements based on respective weight values for the numbers comprises:
program code for identifying a continuous sequence of numbers in the string;
program code for selecting a set of numbers in the continuous sequence;
program code for calculating a weight value for each set of numbers based on multiplying each set of numbers by an integer factor;
program code for identifying a last set of numbers in the continuous sequence;
program code for calculating a weight value for the last set; and
program code for tagging the weight value of the last set.

26. The medium of claim 20, further comprising:
program code for numerically sorting the string in comparison to at least one additional string based on the key and when the at least one attribute indicates numeric ordering.

27. The medium of claim 20, wherein the program code for identifying the first set collation elements for characters that are other than numbers in the string based on the predetermined collation elements comprises program code for identifying Unicode-compliant collation elements for the characters other than numbers in the string.

28. A computer readable medium having program code for configuring a processor to collate strings of characters based on at least one attribute, wherein characters other than numbers are converted into bit sequences based on one or more sets of predetermined collation elements and numeric characters are converted into bit sequences based on an additional set of collation elements that is interleaved within one or more gaps in the sets of predetermined collation elements, said medium comprising:
program code for receiving a first and a second string of characters;
program code for determining whether at least one attribute for the first and second strings indicates numeric ordering;
program code for converting the first and second strings into respective bit sequences based on the predetermined collation elements and the additional set of collation elements when the at least one attribute indicates numeric ordering; and
program code for comparing at least a portion of the bit sequences for the first and second strings; and
program code for numerically sorting the first and second strings of characters based on the comparison of the bit sequences.

29. The medium of claim 28, wherein the predetermined collation elements and additional set of collation elements comprise an array of weight values that indicate levels of linguistic significance, and wherein the program code for numerically sorting the first and second strings of characters comprises:
program code for comparing corresponding portions of the bit sequences;
program code for identifying a difference in a primary level of linguistic significance between the portions of the bit sequences; and
program code for sorting the first and second strings of characters based on the primary level difference.

30. The medium of claim 28, wherein the predetermined collation elements and additional set of collation elements comprise an array of weight values that indicate a level of linguistic significance, and wherein the program code for numerically sorting the first and second strings of characters further comprises:
program code for comparing corresponding portions of the bit sequences;
program code for determining when the bit sequences fail to differ by a first level of linguistic significance;
program code for identifying at least one difference at a second level of linguistic significance between the portions of the bit sequences; and
program code for sorting the strings based on the at least one difference at the second level.

31. A device that handles characters, said device comprising:
a memory that stores a set of predetermined collation elements and one or more sets of keys; and
a processor, coupled to the memory, that is configured to determine whether at least one attribute for strings of characters indicate numeric ordering, identify an open range of values within the set of predetermined collation elements, identify a first set collation elements for characters other than numbers in the strings based on the predetermined collation elements, identify one or more numbers in the strings, determine, for the numbers identified in the strings, an additional set of collation elements having respective sets of weight values based on the location of the open range, and determine a respective key for the strings that is numerically comparable based on the first set of collation elements for the characters other than numbers and the additional set of collation elements for the numbers.

32. The device of claim 31, wherein the first set of collation elements and additional set of collation elements comprise an array of weight values that indicate a range of levels of linguistic significance of each character in the strings and wherein the processor is configured to determine the key based on combining portions of the array of weight values.

33. The device of claim 31, wherein the processor is configured to receive a request for sorting a plurality of strings, retrieve respective keys for each of the plurality of strings based on the request, and sort the plurality of strings based on the respective keys.

34. A device configured to handle strings of characters, said device comprising:
a memory that stores predetermined collation elements and an additional set of collation elements that is interleaved within one or more gaps in the sets of predetermined collation elements; and
a processor, coupled to the memory, that is configured to receive a first and a second string of characters, convert characters other than numbers based on the predetermined collation elements and numeric characters based on the additional set of collation elements into respective first and second bit sequences, determine whether at least one attribute for the first and second strings indicates numeric ordering, and numerically sort the first and second strings based on comparing at least a portion of the first and second bit sequences.

35. The device of claim 34, wherein the memory is configured to store the predetermined collation elements and additional set of collation elements as an array of weight values that indicate levels of linguistic significance, and wherein the processor is configured to numerically sorting the first and second strings of characters based on comparing corresponding portions of the bit sequences, identifying a difference in a primary level of linguistic significance between the portions of the bit sequences, and sorting the first and second strings of characters based on the primary level difference.

36. The device of claim 34, wherein the memory is configured to store the predetermined collation elements and additional set of collation elements as an array of weight values that indicate a level of linguistic significance, and wherein processor is configured to numerically sort the first and second strings of characters based on comparing corresponding portions of the bit sequences, determining when the bit sequences fail to differ by a first level of linguistic significance, identifying at least one difference at a second level of linguistic significance between the portions of the bit sequences, and sorting the strings based on the at least one difference at the second level.
